(19) United States
(12) Patent Application Publication
(10) Pub. No.: US 2025/0196333 A1
(43) Pub. Date: Jun. 19, 2025

(54) ROBOTIC MANIPULATION OF OBJECTS

(71) Applicant: Boston Dynamics, Inc., Waltham, MA (US)

(72) Inventors: Mark Petersen, Woburn, MA (US); Greg Izatt, Watertown, MA (US); Rachel Thomasson, Stanford, CA (US); Alberto Rodriguez, Cambridge, MA (US); Scott Kuindersma, Bedford, MA (US)

(21) Appl. No.: 18/541,256

(22) Filed: Dec. 15, 2023

(51) Int. Cl. B25J 9/16; B25J 15/00

(52) U.S. Cl. CPC B25J 9/1612; B25J 9/163; B25J 9/1666; B25J 9/1682; B25J 15/0004

(57) ABSTRACT

Computer-implemented methods and apparatus for manipulating an object using a robotic device are provided. The method includes associating a first grasp region of an object with an end effector of a robotic device, wherein the first grasp region includes a set of potential grasps achievable by the end effector of the robotic device. The method further includes determining, within the first grasp region, a grasp from among the set of potential grasps, wherein the grasp is determined based, at least in part, on information associated with a capability of the robotic device to perform the grasp, and instructing the robotic device to manipulate the object based on the grasp.

### TECHNICAL FIELD

This disclosure relates generally to robotics and more specifically to systems, methods and apparatuses, including computer programs, for manipulating objects using robotic devices.

### BACKGROUND

Robotic devices are being developed for a variety of purposes today, such as to advance foundational research and to assist with missions that may be risky or taxing for humans to perform. Over time, robots have been tasked with increasingly complicated tasks, such as manipulation of objects. Robots can benefit from improved techniques for planning and coordination of grasps on objects to assist in performing manipulation tasks.

### SUMMARY

Some embodiments of the present disclosure describe systems, methods and apparatuses, including computer programs, for manipulating objects using robotic devices. Many objects that robotic devices may manipulate (e.g., grasp, re-grasp, place) may be grasped in several different ways by the robotic device. Selecting a particular grasp from among the set of possible grasps that allows the robotic device to accomplish a task (e.g., pick-and-place an object, pick-and-use a tool) may involve satisfying one or more objectives (e.g., providing a sufficiently strong hold on an object during transport while avoiding collisions with the robot) while being subject to various constraints (e.g., kinematic constraints of the robot, a balance constraint of the robot). For example, a particular grasp may be selected based on one or more of information about the shape of the object(s), the capabilities of the robot to manipulate the object(s), aspects of the robot's environment, a location of the object(s) relative to the robot, and/or a desired behavior for the robot to perform while manipulating the object(s).

In some prior robotic devices, grasping an object involves (i) determining how to grasp the object (e.g., where to grasp the object) and (ii) determining how to move components of the robot to achieve the determined grasp. The inventors have recognized that prior approaches that decouple these two steps have challenges. For example, if it is determined in step (ii) that the robot is unable to move in a way that enables the robot to successfully grasp the object as determined in step (i), the attempted grasp may fail and/or step (i) may need to be repeated until the conditions in both steps can be satisfied.

Some embodiments of the present disclosure relate to improved techniques for robotic grasp planning and object manipulation using grasp regions associated with an object. Within each grasp region a continuous set of potential grasps may be achieved by an end effector of a robotic device. As described in further detail below, the use of grasp regions in grasp planning and object manipulation provides flexibility in how the robotic device is able to manipulate an object relative to prior techniques.

In one aspect, the invention features a computer-implemented method. The method includes associating a first grasp region of an object with an end effector of a robotic device, wherein the first grasp region includes a set of potential grasps achievable by the end effector of the robotic device, determining, within the first grasp region, a grasp from among the set of potential grasps, wherein the grasp is determined based, at least in part, on information associated with a capability of the robotic device to perform the grasp, and instructing the robotic device to manipulate the object based on the grasp.

In one aspect, the method further includes defining a set of grasp regions for the object, wherein the set of grasp regions includes the first grasp region. In another aspect, the method defining the set of grasp regions for the object is based, at least in part, on a shape of the object and/or information associated with at least one end effector of the robotic device. In another aspect, defining the set of grasp regions for the object comprises fitting one or more primitive shapes to the object. In another aspect, the one or more primitive shapes include at least one of a cylinder, a prism, a disk, or a plane. In another aspect, the at least one end effector of the robotic device includes a robotic gripper having a set of appendages, and defining the set of grasp regions for the object comprises defining the first grasp region as having a shape capable of being grasped by at least two appendages in the set of appendages. In another aspect, the shape capable of being grasped by at least two appendages in the set of appendages includes a cylinder, a prism or a disk. In another aspect, the shape capable of being grasped by at least two appendages in the set of appendages is defined along a single axis, and the set of potential grasps within the first grasp region include grasps having different rotations around the single axis and/or translations along the single axis. In another aspect, the at least one end effector of the robotic device includes a suction-based gripper, and defining the set of grasp regions for the object comprises defining the first grasp region as a substantially planar region configured to be grasped by the suction-based gripper. In another aspect, defining a set of grasp regions for the object comprises determining using simulation, a set of possible grasps of the at least one end effector on the object, clustering possible grasps within the set of possible grasps to generate a set of clusters, and defining the set of grasp regions based on the set of clusters.

In another aspect, the end effector of the robotic device includes a gripper having a set of appendages, and the first grasp region has a shape capable of being grasped by at least two appendages of the set of appendages. In another aspect, the shape capable of being grasped by at least two appendages of the set of appendages includes a cylinder, a prism or a disk. In another aspect, the shape capable of being grasped by at least two appendages of the set of appendages is defined along a single axis, and the set of potential grasps within the first grasp region include grasps having different rotations around the single axis and/or translations along the single axis. In another aspect, determining, within the first grasp region, a grasp, comprises determining the grasp based, at least in part, on a pose of the robotic device.

In another aspect, determining, within the first grasp region, a grasp, comprises determining the grasp based, at least in part, on a manipulation goal of the robotic device. In another aspect, the grasp is determined based, at least in part, on a placement location of the object associated with the manipulation goal. In another aspect, the grasp is determined based, at least in part, on a location of the object prior to manipulating the object. In another aspect, determining, within the first grasp region, a grasp, comprises determining the grasp based, at least in part, on a balance constraint of the robotic device when manipulating the object.

In another aspect, determining, within the first grasp region, a grasp, comprises determining the grasp based, at least in part, on a collision constraint associated with the robotic device when manipulating the object. In another aspect, the collision constraint is a self-collision constraint of the robotic device and/or an external collision constraint of the robotic device with an object in an environment of the robotic device. In another aspect, determining, within the first grasp region, a grasp, comprises determining the grasp based, at least in part, on a gaze constraint associated with a camera of the robotic device when manipulating the object. In another aspect, determining, within the first grasp region, a grasp, comprises determining the grasp based, at least in part, on one or more kinematic constraints of the robotic device.

In another aspect, determining, within the first grasp region, a grasp, comprises determining the grasp using a technique that considers for each potential grasp in the set of potential grasps within the first grasp region, a location of the potential grasp within the first grasp region, and one or more kinematic or reachability constraints of the robotic device to achieve the potential grasp. In another aspect, the technique is an optimization technique. In another aspect, the first grasp region has a first axis, and the set of potential grasps within the first grasp region include potential grasps at different rotations around the first axis and/or translations along the first axis.

In another aspect, manipulating the object based on the grasp comprises controlling the robotic device to grasp the object using the grasp. In another aspect, manipulating the object based on the grasp comprises controlling the robotic device to re-grasp the object using the grasp. In another aspect, re-grasping the object is performed during movement of the object from a first location to a second location. In another aspect, re-grasping the object comprises rotating a grasp of the object by the end effector of the robotic device within the first grasp region. In another aspect, re-grasping the object comprises translating a grasp of the object by the end effector of the robotic device along a first axis of the first grasp region. In another aspect, re-grasping the object is performed in response to detecting that the object is slipping relative to the end effector of the robotic device. In another aspect, manipulating the object based on the grasp comprises controlling the robotic device to place the object at a location using the grasp.

In another aspect, the end effector is a first end effector of the robotic device, the grasp is a first grasp for the first end effector, the information associated with the capability of the robotic device to perform the grasp is first information, and the robotic device includes a second end effector. The method further includes assigning a second grasp region to the second end effector, determining, within the second grasp region, a second grasp for the second end effector, wherein the second grasp is determined based, at least in part, on second information associated with a capability of the robotic device to perform the second grasp, and manipulating the object based on the first grasp and the second grasp. In another aspect, determining the first grasp and the second grasp comprises using a technique that considers the first information and the second information. In another aspect, the first grasp region is located on an opposite side of the object from the second grasp region. In another aspect, the first grasp region is located at a different height on the object from the second grasp region to improve stability of the object when manipulated by the robotic device.

In some embodiments, the invention features a computing system of a robot. The computing system includes data processing hardware and memory hardware in communication with the data processing hardware. The memory hardware is configured to store instructions that when executed on the data processing hardware cause the data processing hardware to perform operations. The operations include associating a first grasp region of an object with an end effector of the robot, wherein the first grasp region includes a set of potential grasps achievable by the end effector of the robot, determining, within the first grasp region, a grasp, wherein the grasp is determined based, at least in part, on information associated with a capability of the robot to perform the grasp, and instructing the robot to manipulate the object based on the grasp.

In one aspect, the operations further include defining a set of grasp regions for the object, wherein the set of grasp regions includes the first grasp region. In another aspect, defining the set of grasp regions for the object is based, at least in part, on a shape of the object and/or information associated with at least one end effector of the robot. In another aspect, defining the set of grasp regions for the object comprises fitting one or more primitive shapes to the object. In another aspect, the one or more primitive shapes include at least one of a cylinder, a prism, a disk, or a plane.

In another aspect, the end effector of the robot includes a robotic gripper having a set of appendages, and defining the set of grasp regions for the object comprises defining the first grasp region as having a shape capable of being grasped by at least two appendages in the set of appendages. In another aspect, the shape capable of being grasped by at least two appendages in the set of appendages includes a cylinder, a prism or a disk. In another aspect, the shape capable of being grasped by at least two appendages in the set of appendages is defined along a single axis, and the set of potential grasps within the first grasp region include grasps having different rotations around the single axis and/or translations along the single axis. In another aspect the at least one end effector of the robot includes a suction-based gripper, and defining the set of grasp regions for the object comprises defining the first grasp region as a substantially planar region configured to be grasped by the suction-based gripper. In another aspect, defining a set of grasp regions for the object comprises determining using simulation, a set of possible grasps of the at least one end effector on the object, clustering possible grasps within the set of possible grasps to generate a set of clusters, and defining the set of grasp regions based on the set of clusters.

In another aspect, the end effector of the robot includes a gripper having a set of appendages, and the first grasp region has a shape capable of being grasped by at least two appendages of the set of appendages. In another aspect, the shape capable of being grasped by at least two appendages of the set of appendages includes a cylinder, a prism or a disk. In another aspect, the shape capable of being grasped by at least two appendages of the set of appendages is defined along a single axis, and the set of potential grasps within the first grasp region include grasps having different rotations around the single axis and/or translations along the single axis. In another aspect, determining, within the first grasp region, a grasp, comprises determining the grasp based, at least in part, on a pose of the robot.

In another aspect, determining, within the first grasp region, a grasp, comprises determining the grasp based, at least in part, on a manipulation goal of the robot. In another aspect, the grasp is determined based, at least in part, on a placement location of the object associated with the manipulation goal. In another aspect, the grasp is determined based, at least in part, on a location of the object prior to manipulating the object. In another aspect, determining, within the first grasp region, a grasp, comprises determining the grasp based, at least in part, on a balance constraint of the robot when manipulating the object.

In another aspect, determining, within the first grasp region, a grasp, comprises determining the grasp based, at least in part, on a collision constraint associated with the robot when manipulating the object. In another aspect, the collision constraint is a self-collision constraint of the robot and/or an external collision constraint of the robot with an object in an environment of the robot. In another aspect, determining, within the first grasp region, a grasp, comprises determining the grasp based, at least in part, on a gaze constraint associated with a camera of the robot when manipulating the object. In another aspect, determining, within the first grasp region, a grasp, comprises determining the grasp based, at least in part, on one or more kinematic constraints of the robot.

In another aspect, determining, within the first grasp region, a grasp, comprises determining the grasp using a technique that considers for each potential grasp in the set of potential grasps within the first grasp region, a location of the potential grasp within the first grasp region, and one or more kinematic or reachability constraints of the robot to achieve the potential grasp. In another aspect, the technique is an optimization technique. In another aspect, the first grasp region has a first axis, and the set of potential grasps within the first grasp region include potential grasps at different rotations around the first axis and/or translations along the first axis.

In another aspect, manipulating the object based on the grasp comprises controlling the robot to grasp the object using the grasp. In another aspect, manipulating the object based on the grasp comprises controlling the robot to re-grasp the object using the grasp. In another aspect, re-grasping the object is performed during movement of the object from a first location to a second location. In another aspect, re-grasping the object comprises rotating a grasp of the object by the end effector of the robot within the first grasp region. In another aspect, re-grasping the object comprises translating a grasp of the object by the end effector of the robot along a first axis of the first grasp region. In another aspect, re-grasping the object is performed in response to detecting that the object is slipping relative to the end effector of the robot. In another aspect, manipulating the object based on the grasp comprises controlling the robot to place the object at a location using the grasp.

In another aspect, the end effector is a first end effector of the robot, the grasp is a first grasp for the first end effector, the information associated with the capability of the robot to perform the grasp is first information, and the robot includes a second end effector. The operations further include assigning a second grasp region to the second end effector, determining, within the second grasp region, a second grasp for the second end effector, wherein the second grasp is determined based, at least in part, on second information associated with a capability of the robot to perform the second grasp, and manipulating the object based on the first grasp and the second grasp. In another aspect, determining the first grasp and the second grasp comprises using a technique that considers the first information and the second information. In another aspect, the first grasp region is located on an opposite side of the object from the second grasp region. In another aspect, the first grasp region is located at a different height on the object from the second grasp region to improve stability of the object when manipulated by the robot.

In some embodiments, the invention features a robot. The robot including an end effector, data processing hardware and memory hardware in communication with the data processing hardware. The memory hardware is configured to store instructions that when executed on the data processing hardware cause the data processing hardware to perform operations. The operations include associating a first grasp region of an object with the end effector, wherein the first grasp region includes a set of potential grasps achievable by the end effector, determining, within the first grasp region, a grasp, wherein the grasp is determined based, at least in part, on information associated with a capability of the robot to perform the grasp, and instructing the robot to manipulate the object based on the grasp.

In one aspect, the operations further include defining a set of grasp regions for the object, wherein the set of grasp regions includes the first grasp region. In another aspect, defining the set of grasp regions for the object is based, at least in part, on a shape of the object and/or information associated with at least one end effector of the robot. In another aspect, defining the set of grasp regions for the object comprises fitting one or more primitive shapes to the object. In another aspect, the one or more primitive shapes include at least one of a cylinder, a prism, a disk, or a plane.

In another aspect, the end effector includes a robotic gripper having a set of appendages, and defining the set of grasp regions for the object comprises defining the first grasp region as having a shape capable of being grasped by at least two appendages in the set of appendages. In another aspect, the shape capable of being grasped by at least two appendages in the set of appendages includes a cylinder, a prism or a disk. In another aspect, the shape capable of being grasped by at least two appendages in the set of appendages is defined along a single axis, and the set of potential grasps within the first grasp region include grasps having different rotations around the single axis and/or translations along the single axis. In another aspect, the at least one end effector of the robot includes a suction-based gripper, and defining the set of grasp regions for the object comprises defining the first grasp region as a substantially planar region configured to be grasped by the suction-based gripper.

In another aspect, defining a set of grasp regions for the object comprises determining using simulation, a set of possible grasps of the at least one end effector on the object, clustering possible grasps within the set of possible grasps to generate a set of clusters, and defining the set of grasp regions based on the set of clusters. In another aspect, the end effector of the robot includes a gripper having a set of appendages, and the first grasp region has a shape capable of being grasped by at least two appendages of the set of appendages. In another aspect, the shape capable of being grasped by at least two appendages of the set of appendages includes a cylinder, a prism or a disk. In another aspect, the shape capable of being grasped by at least two appendages of the set of appendages is defined along a single axis, and the set of potential grasps within the first grasp region include grasps having different rotations around the single axis and/or translations along the single axis.

In another aspect, determining, within the first grasp region, a grasp, comprises determining the grasp based, at least in part, on a pose of the robot. In another aspect, determining, within the first grasp region, a grasp, comprises determining the grasp based, at least in part, on a manipulation goal of the robot. In another aspect, the grasp is determined based, at least in part, on a placement location of the object associated with the manipulation goal. In another aspect, the grasp is determined based, at least in part, on a location of the object prior to manipulating the object. In another aspect, determining, within the first grasp region, a grasp, comprises determining the grasp based, at least in part, on a balance constraint of the robot when manipulating the object.

In another aspect, determining, within the first grasp region, a grasp, comprises determining the grasp based, at least in part, on a collision constraint associated with the robot when manipulating the object. In another aspect, the collision constraint is a self-collision constraint of the robot and/or an external collision constraint of the robot with an object in an environment of the robot. In another aspect, determining, within the first grasp region, a grasp, comprises determining the grasp based, at least in part, on a gaze constraint associated with a camera of the robot when manipulating the object. In another aspect, determining, within the first grasp region, a grasp, comprises determining the grasp based, at least in part, on one or more kinematic constraints of the robot.

In another aspect, determining, within the first grasp region, a grasp, comprises determining the grasp using a technique that considers for each potential grasp in the set of potential grasps within the first grasp region, a location of the potential grasp within the first grasp region, and one or more kinematic or reachability constraints of the robot to achieve the potential grasp. In another aspect, the technique is an optimization technique. In another aspect, the first grasp region has a first axis, and the set of potential grasps within the first grasp region include potential grasps at different rotations around the first axis and/or translations along the first axis.

In another aspect, manipulating the object based on the grasp comprises controlling the robot to grasp the object using the grasp. In another aspect, manipulating the object based on the grasp comprises controlling the robot to re-grasp the object using the grasp. In another aspect, re-grasping the object is performed during movement of the object from a first location to a second location. In another aspect, re-grasping the object comprises rotating a grasp of the object by the end effector of the robot within the first grasp region. In another aspect, re-grasping the object comprises translating a grasp of the object by the end effector of the robot along a first axis of the first grasp region. In another aspect, re-grasping the object is performed in response to detecting that the object is slipping relative to the end effector of the robot. In another aspect, manipulating the object based on the grasp comprises controlling the robot to place the object at a location using the grasp.

In another aspect, the end effector is a first end effector, the grasp is a first grasp for the first end effector, the information associated with the capability of the robot to perform the grasp is first information, and the robot includes a second end effector. The operations further include assigning a second grasp region to the second end effector, determining, within the second grasp region, a second grasp for the second end effector, wherein the second grasp is determined based, at least in part, on second information associated with a capability of the robot to perform the second grasp, and manipulating the object based on the first grasp and the second grasp. In another aspect, determining the first grasp and the second grasp comprises using a technique that considers the first information and the second information. In another aspect, the first grasp region is located on an opposite side of the object from the second grasp region. In another aspect, the first grasp region is located at a different height on the object from the second grasp region to improve stability of the object when manipulated by the robot.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1 illustrates an example configuration of a robotic device, according to an illustrative embodiment of the invention.

FIG. 2A illustrates an example of a humanoid robot, according to an illustrative embodiment of the invention.

FIG. 2B illustrates an example of another humanoid robot, according to an illustrative embodiment of the invention.

FIG. 3 illustrates an example computing architecture for a robotic device, according to an illustrative embodiment of the invention.

FIGS. 4A-4C illustrate different types of grasp regions on an object, according to an illustrative embodiment of the invention.

FIGS. 5A-5C illustrate sets of potential grasp positions within a grasp region, according to an illustrative embodiment of the invention.

FIGS. 6A and 6B illustrate potential grasp positions within a cylindrical grasp region, according to an illustrative embodiment of the invention.

FIG. 7A illustrates an example object having a set of potential grasp points, according to an illustrative embodiment of the invention.

FIG. 7B illustrates the example object of FIG. 7A having a set of grasp regions superimposed thereon, according to an illustrative embodiment of the invention.

FIG. 8 is a flowchart of an exemplary computer-implemented method for determining one or more grasp regions of an object, according to an illustrative embodiment of the invention.

FIG. 9 is a flowchart of an alternative exemplary computer-implemented method for determining one or more grasp regions of an object, according to an illustrative embodiment of the invention.

FIG. 10A illustrates a first grasp of an example object by a robotic device when the object is located at a high position, according to an illustrative embodiment of the invention.

FIG. 10B illustrates a second grasp of the example object shown in FIG. 10A by a robotic device when the object is located at a low position, according to an illustrative embodiment of the invention.

FIG. 11 is a flowchart of an exemplary computer-implemented method, according to an illustrative embodiment of the invention.

### DETAILED DESCRIPTION

An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system may have stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device). For instance, the control system may determine locations at which to place the robotic device's feet and/or the force to exert by the robotic device's feet on a surface based on the aggregate orientation.

In some implementations, the robotic device may include force sensors that measure or estimate the external forces (e.g., the force applied by a leg of the robotic device against the ground) along with kinematic sensors to measure the orientation of the limbs of the robotic device. The processing system may be configured to determine the robotic device's angular momentum based on information measured by the sensors.

The control system may be configured to actuate one or more actuators connected across components of a robotic leg. The actuators may be controlled to raise or lower the robotic leg. In some cases, a robotic leg may include actuators to control the robotic leg's motion in three dimensions. Depending on the particular implementation, the control system may be configured to use the aggregate orientation, along with other sensor measurements, as a basis to control the robot in a certain manner (e.g., stationary balancing, walking, running, galloping, etc.).

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

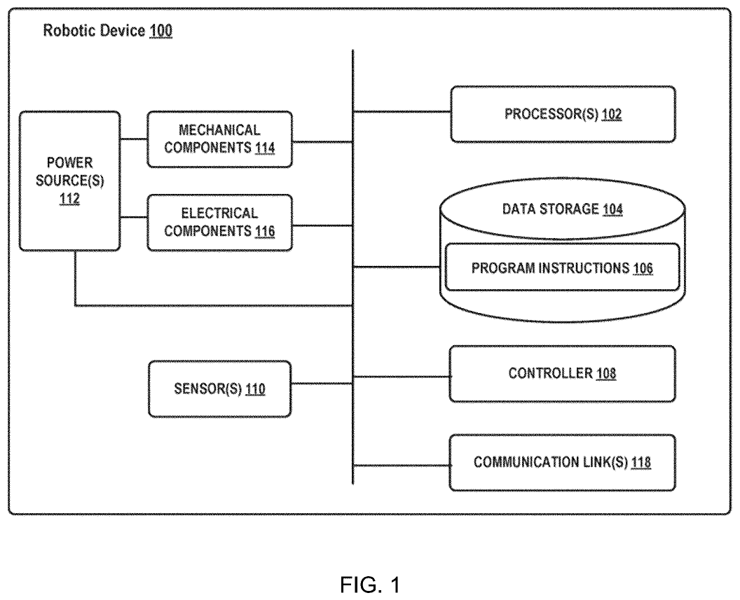

Referring now to the figures, FIG. 1 illustrates an example configuration of a robotic device (or “robot”) 100, according to an illustrative embodiment of the invention. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disk storage, which can be integrated in whole or in part with processor(s) 102. In some implementations, the data storage 104 can be implemented using a single physical device (e.g., one optical, magnetic, organic or other memory or disk storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic device 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic device 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such as the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic device 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic device 100 may connect to multiple power sources as well.

Within example configurations, any type of power source may be used to power the robotic device 100, such as a gasoline and/or electric engine. Further, the power source(s) 112 may be charged using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100.

Mechanical components 114 can represent hardware of the robotic device 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The particular mechanical components 114 used may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, and/or providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information sensed by sensor(s) 110 may be transmitted via the communication link(s) 118 to a separate device. Other diagnostic information indicating the integrity or health of the power source(s) 112, mechanical components 114, electrical components 116, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 and/or the electrical components 116. In some cases, the received information may indicate a query requesting a particular piece of information (e.g., the operational state of one or more of the components of the robotic device 100), and the processor(s) 102 may subsequently transmit that particular piece of information via the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

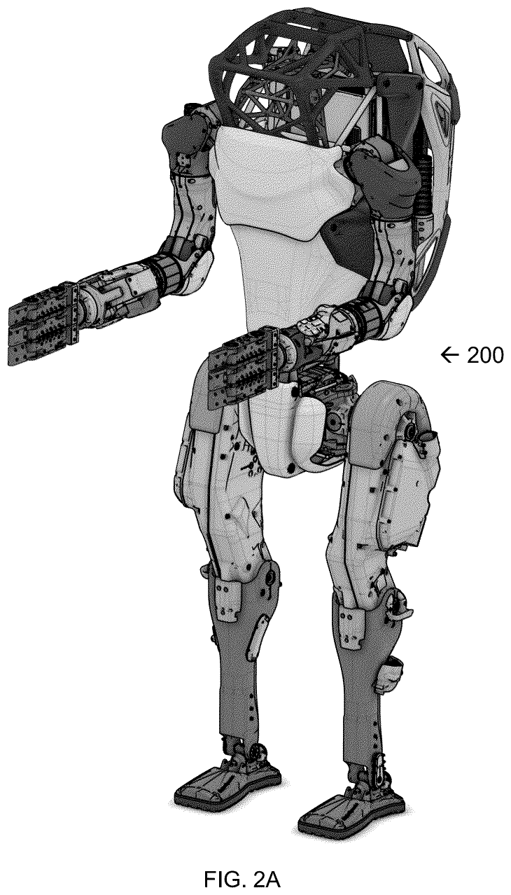

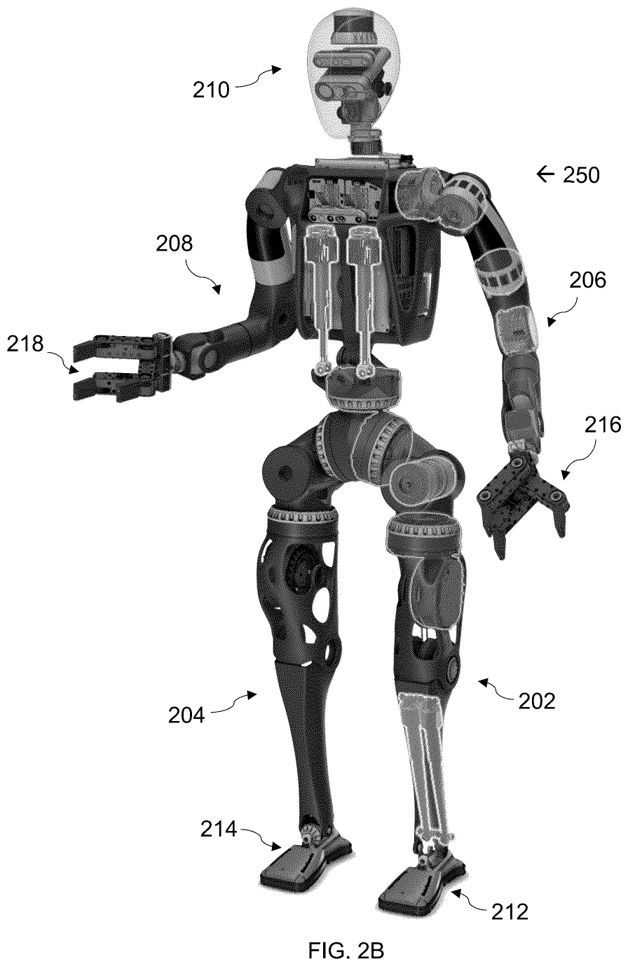

FIG. 2A illustrates an example of a humanoid robot (or robotic device) 200, according to an illustrative embodiment of the invention. The robotic device 200 may correspond to the robotic device 100 shown in FIG. 1. The robotic device 200 serves as a possible implementation of a robotic device that may be configured to include the systems and/or carry out the methods described herein. Other example implementations of robotic devices may exist.

The robotic device 200 may include a number of articulated appendages, such as robotic legs and/or robotic arms. Each articulated appendage may include a number of members connected by joints that allow the articulated appendage to move through certain degrees of freedom. Each member of an articulated appendage may have properties describing aspects of the member, such as its weight, weight distribution, length, and/or shape, among other properties. Similarly, each joint connecting the members of an articulated appendage may have known properties, such as the degrees of its range of motion the joint allows, the size of the joint, and the distance between members connected by the joint, among other properties. A given joint may be a joint allowing one degree of freedom (e.g., a knuckle joint or a hinge joint), a joint allowing two degrees of freedom (e.g., a cylindrical joint), a joint allowing three degrees of freedom (e.g., a ball and socket joint), or a joint allowing four or more degrees of freedom. A degree of freedom may refer to the ability of a member connected to a joint to move about a particular translational or rotational axis.

The robotic device 200 may also include sensors to measure the angles of the joints of its articulated appendages. In addition, the articulated appendages may include a number of actuators that can be controlled to extend and retract members of the articulated appendages. In some cases, the angle of a joint may be determined based on the extent of protrusion or retraction of a given actuator. In some instances, the joint angles may be inferred from position data of inertial measurement units (IMUs) mounted on the members of an articulated appendage. In some implementations, the joint angles may be measured using rotary position sensors, such as rotary encoders. In other implementations, the joint angles may be measured using optical reflection techniques. Other joint angle measurement techniques may also be used.

The robotic device 200 may be configured to send sensor data from the articulated appendages to a device coupled to the robotic device 200 such as a processing system, a computing system, or a control system. The robotic device 200 may include a memory, either included in a device on the robotic device 200 or as a standalone component, on which sensor data is stored. In some implementations, the sensor data is retained in the memory for a certain amount of time. In some cases, the stored sensor data may be processed or otherwise transformed for use by a control system on the robotic device 200. In some cases, the robotic device 200 may also transmit the sensor data over a wired or wireless connection (or other electronic communication means) to an external device.

FIG. 2B illustrates an example of another humanoid robot 250, according to an illustrative embodiment of the invention. The humanoid robot 250 may correspond to the robotic device 100 shown in FIG. 1. The humanoid robot 250 serves as a possible implementation of a robotic device that may be configured to include the systems and/or carry out the methods described herein, but other implementations are also possible.

The humanoid robot 250 may include a number of articulated appendages, such as robotic legs 202, 204 and/or robotic arms 206, 208. The humanoid robot 250 may also include a robotic head 210, which may contain one or more vision sensors (e.g., cameras, infrared sensors, object sensors, range sensors, etc.). Each articulated appendage may include a number of members connected by joints that allow the articulated appendage to move through certain degrees of freedom. For example, each robotic leg 202, 204 may include a respective foot 212, 214, which may contact a surface (e.g., a ground surface). The legs 202, 204 may enable the robot 250 to travel at various speeds according to various gaits. In addition, each robotic arm 206, 208 may facilitate object manipulation, load carrying, and/or balancing of the robot 250. Each arm 206, 208 may also include one or more members connected by joints and may be configured to operate with various degrees of freedom. Each arm 206, 208 may also include a respective end effector (e.g., gripper, hand, etc.) 216, 218. The robot 250 may use end effectors 216, 218 for interacting with (e.g., gripping, turning, pulling, and/or pushing) objects. Each end effector 216, 218 may include various types of appendages or attachments, such as fingers, attached tools or grasping mechanisms.

The robot 250 may also include sensors to measure the angles of the joints of its articulated appendages. In addition, the articulated appendages may include a number of actuators that can be controlled to extend and/or retract members of the articulated appendages. In some embodiments, the angle of a joint may be determined based on the extent of protrusion and/or retraction of a given actuator. In some embodiments, the joint angles may be inferred from position data of inertial measurement units (IMUs) mounted on the members of an articulated appendage. In some embodiments, the joint angles may be measured using rotary position sensors, such as rotary encoders. In some embodiments, the joint angles may be measured using optical reflection techniques. Other joint angle measurement techniques may also be used.

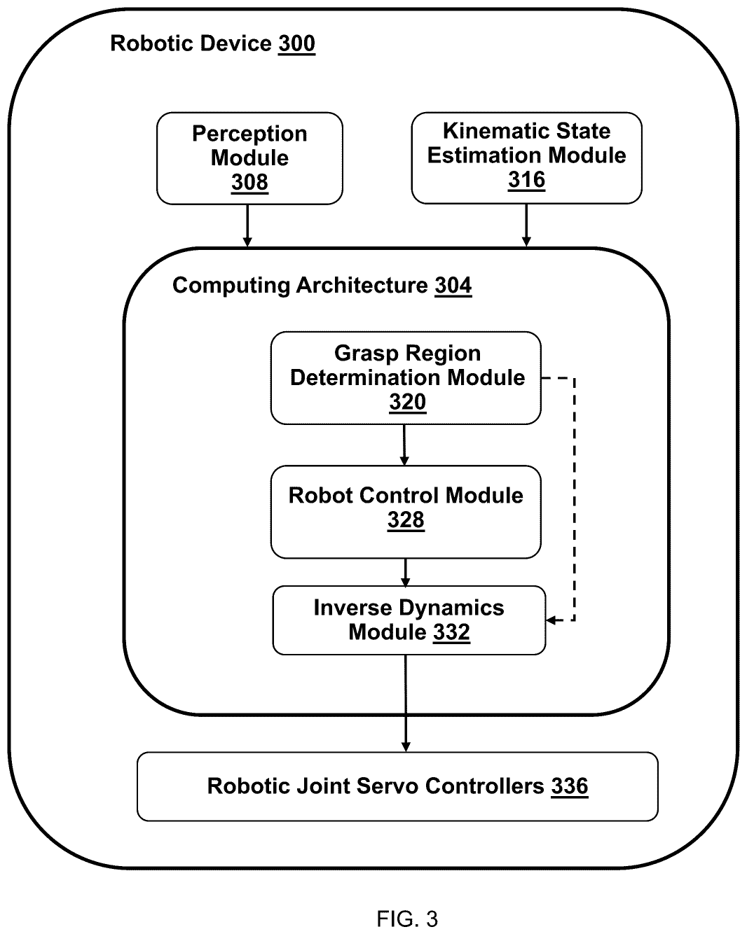

FIG. 3 illustrates an example computing architecture 304 for a robotic device 300, according to an illustrative embodiment of the invention. The computing architecture 304 includes grasp region determination module 320, a robot control module 328, and an inverse dynamics module 332. The robotic device 300 also includes a perception module 308, kinematic state estimation module 316, and robotic joint servo controllers 336, which can interact with (e.g., provide input to and/or receive output from) the computing architecture 304. One having ordinary skill in the art will appreciate that the components shown in FIG. 3 are exemplary, and other modules and/or configurations of modules are also possible. For example, in some embodiments, the inverse dynamics module 332 may be included as part of the robot control module 328. Some embodiments may include a planner module (not shown), arranged between the grasp region determination module 320 and the robot control module 328. The planner module may be configured to select a grasp within a grasp region output from grasp region determination module 320 and determine an initial estimate for a whole body posture for the robotic device to achieve the selected grasp. The selected grasp and initial estimate for the whole body posture may be provided as input to robot control model 328. In other embodiments, functionality of such a planner module may be incorporated in robot control module 328.

The perception module 308 may be configured to perceive one or more aspects of the environment of the robotic device 300 and/or provide input reflecting the environment to the computing architecture 304 (e.g., input reflecting an object to be manipulated by the robotic device). For example, in some embodiments, the perception module 308 can sense aspects of the environment using a RGB camera, a depth camera, a LIDAR or stereo vision device, or another piece of equipment with suitable sensory capabilities. In some embodiments, one or more additional modules (not shown in FIG. 3) can capture other sensory-based input (e.g., force sensing, which may be implemented at one or more end effectors of the robotic device 300), which may provide additional input to the computing architecture 304.

The kinematic state estimation module 316 may be configured to track kinematic data for the robotic device 300 (e.g., a form of “robot data”) and/or one or more grasped objects (e.g., a form of “object data”). In some embodiments, the kinematic data for the robotic device 300 includes one or more vectors, which may include joint positions, joint velocities, joint accelerations, angular orientations, angular velocities, angular accelerations, sensed forces, or other parameters suitable to characterize the kinematics of the robotic device 300 and/or one or more grasped objects.

As described above, some prior art techniques for grasping and manipulating objects with a robotic device are inflexible due to their commitment to a single grasp prior to determining whether the robot is capable to move in such a way to perform the grasp. The inventors have recognized and appreciated that it may be useful to have flexibility to choose between a set of grasps when planning object manipulation behaviors for a robotic device. In some tasks, and for many objects, there are an infinite number of potential discrete grasps, with the difference between them being a continuous rotation and/or translation along an axis or other motion across a manifold of the object. Some conventional grasp techniques may attempt to identify an optimal grasp from among the infinite set of grasps using a machine learning (e.g., neural network) approach. However, such an approach may require considerable computation power and take considerable time due to the requirement to search over a large surface of the object. Some embodiments narrow the set of infinite grasps by defining grasp regions for an object, each of which represents a set of potential grasps using a low dimensional continuous parametric set of parameters. In some embodiments, a grasp region may be implemented as a parameterization that may be easily translated into a continuous optimization. By contrast, some conventional grasping techniques describe graspable parts of an object implicitly by creating a function representing the quality of a single grasp, and searching for grasps by sampling or a form of gradient ascent. Some embodiments separate the continuous choice (where in a grasp region to grasp) from the discrete choice (which grasp region to use), which facilitates incorporation into a continuous optimization process that includes other objectives and/or constraints.

Based on the information received from the perception module 308 and/or the kinematic state estimation module 316 (and/or other sensory modules not shown in FIG. 3, but described above), the grasp region determination module 320 may be configured to determine one or more grasp regions for an object in the environment of the robotic device 300. In some embodiments, the shape and/or extent of grasp region(s) may be determined based, at least in part, on the configuration and/or capabilities of the robotic device 300. For instance, if the robotic device 300 includes at least one end effector configured to grasp an object by at least partially enveloping a portion of the object (e.g., a claw or hand end effector with a set of appendages or fingers configured to at least partially envelop a handle of an object), the shapes of the grasp region(s) may correspond to shapes that may be grasped by such an end effector (e.g., cylinders, prisms, disks, etc.). As another example, if the robotic device 300 includes at least one suction-based end effector, the shapes of the grasp region(s) may correspond to flat (or substantially flat) surfaces on the object that may be grasped by such an end effector (e.g., using suction).

In some embodiments, a set of grasp regions for an object may be determined “offline,” and the set of grasp regions for an object that was determined offline may be accessed “online” by grasp region determination module 320 during operation of the robotic device. During operation of the robotic device, one or more modules of the robotic device may be configured to determine, for example, which end effector(s) of the robotic device to grasp the object with, which grasp region(s) to associate with each end effector(s), and which grasp from a set of potential grasps within the grasp region along with the whole-body robot posture to use to achieve the grasp.

In some embodiments, a set of potential grasps within a grasp region may be defined relative to a single axis of the grasp region. For example, a cylindrical grasp region may have a single axis and a set of potential grasps within the grasp region may be defined as rotations around the single axis and/or translations along the single axis. Such a grasp region may be suitable to characterize objects that have cylindrical portions. For instance, if the object is a pole, a single-hand grasp on the pole can rotate about the length of the pole or slide along it and still remain a feasible grasp for grasping the pole.

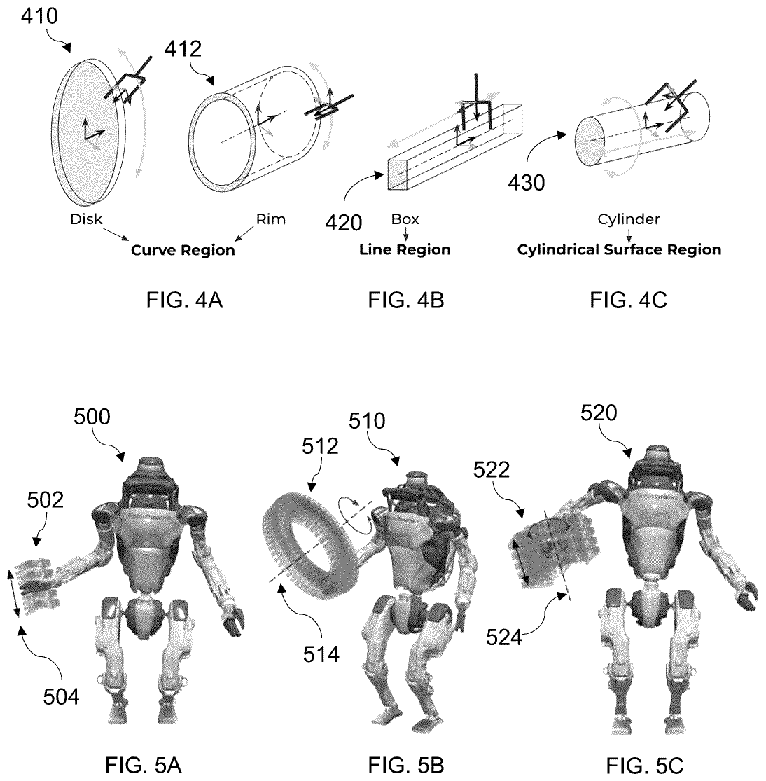

FIGS. 4A-4C schematically illustrate examples of grasp regions that may be defined along a single axis, in accordance with some embodiments of the present disclosure. FIG. 4A illustrates examples of curved grasp regions corresponding to a disk 410 or a rim 412 of an object, which can be grasped by a claw end effector around the circumference of the curved grasp region. FIG. 4B illustrates an example of a line grasp region corresponding to a face 420 of an object (e.g., a box), which can be grasped by an end effector on one of the four faces oriented around the object and at a location along the length of the object. FIG. 4C illustrates a cylindrical grasp region 430 of an object (e.g., a cylinder). As described above, the cylindrical grasp region 430 may be grasped by an end effector at any point around its circumference and at any location along the length of the object.

FIGS. 5A-5C schematically illustrate examples of grasp regions defined along a single axis (e.g., the grasp regions shown in FIGS. 4A-4C) mapped onto a rendering of a robotic device (e.g., a humanoid robot), in accordance with some embodiments of the present disclosure. As shown in FIGS. 5A and 5B, the kinematics of the robot constrain the potential grasps within the different grasp regions. FIG. 5A illustrates that when the grasp region 502 is defined along a single axis 504, the robotic device 500 may grasp the object at any point along the single axis 504 by moving its end effector along the axis 504. FIG. 5B illustrates that when the grasp region 512 is defined along a single axis 514, the robotic device 510 may grasp the object at any point along a circumference of the object (e.g., a rotation around the single axis 514) within the grasp region 512. FIG. 5C illustrates that when the grasp region 522 is defined along a single axis 524, the robotic device 520 may grasp the object as any combination of rotation around and/or translation along the single axis 524.

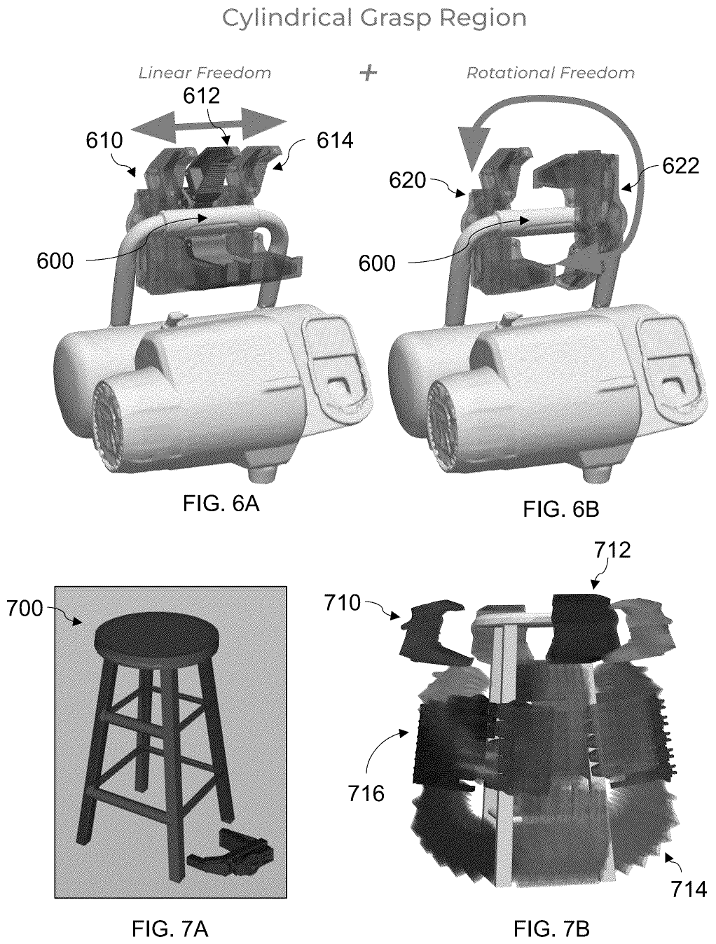

FIG. 6A-6B schematically represent an example of a cylindrical grasp region defined along a single axis of a handle of an object, in accordance with some embodiments of the present disclosure. FIGS. 6A-6B illustrate that a handle 600 of an object to be grasped (or currently grasped) by a robotic device may be represented by a cylindrical grasp region that has a single axis along the length of the handle.

FIG. 6A shows examples of potential grasps within the cylindrical grasp region as a claw end effector translates along the axis of the cylindrical grasp region. For instance, a first potential grasp 610 of the claw end effector may occur at a location at a left end of the grasp region, a second potential grasp 612 of the claw end effector may occur at a location at a middle of the grasp region, and a third potential grasp 614 of the claw end effector may occur at a location at a right end of the grasp region. Although only three potential grasps are shown in the example of FIG. 6A, it should be appreciated that the grasp region may represent a continuous (e.g., uniform) set of potential grasps along the axis of the grasp region of handle 600.

FIG. 6B shows examples of potential grasps within the cylindrical grasp region as a claw end effector rotates around the axis of the cylindrical grasp region. In particular, FIG. 6B shows a first potential grasp 620 of the claw end effector and a second potential grasp 622 of the claw end effector, where the second potential grasp 622 is an inverted grasp relative to the first potential grasp 620. Although only two potential grasps are shown in the example of FIG. 6B, it should be appreciated that the grasp region may represent a continuous (e.g., uniform) set of potential grasps around the axis of the grasp region of handle 600. When considering both the linear freedom and the rotational freedom afforded by the cylindrical grasp region shown in FIGS. 6A and 6B, it should be appreciated that the grasp region represents a set of potential grasps that have any combination of translation and/or rotation relative to the axis of the grasp region.

In some embodiments, a grasp selected from the set of potential grasps may be selected based, at least in part, on a quality of the grasp and/or other information including, but not limited to, capabilities of the robotic device to grasp the object given certain behaviors the robotic device attempts to perform. For instance, a potential grasp that combines the potential grasps 612 and 622 may be selected to grasp the handle 600 when it is determined that the grasp quality of that potential grasp is the highest for a given manipulation task the robotic device is to perform.

FIGS. 6A-6B schematically illustrate an object having a single grasp region. However, it should be appreciated that objects that may be grasped by a robotic device, in accordance with some embodiments of the present disclosure, may have multiple portions that may be grasped by the robotic device, and one or more of these multiple portions may be represented by a separate grasp region. FIG. 7A illustrates an example of an object 700 (e.g., a stool) having multiple portions that may be grasped by a robotic device using one or more of the techniques described herein. For instance, the circular seat of the object 700 forms a disk that could be grasped at any point along its circumference. Alternatively, each of the four legs of the object 700 has vertical sections that could be grasped at various locations and/or rotations about their vertical length. Yet further still, the object 700 includes cross portions connecting adjacent sets of legs that could be grasped at any location along their horizontal length and at any rotation around the cross portions.

The inventors have recognized that it may be useful to reduce the large (e.g., infinite) number of potential grasps of an object to a discrete set of grasp regions as shown in FIG. 7B. In the example of FIG. 7B, twenty grasp regions, each of which includes a continuous set of potential grasps are mapped onto the different portions of the object 700 shown in FIG. 7A. For instance, four curved grasp regions (including grasp regions 710 and 712) each represent a set of potential grasps of the seat of the object 700 at locations around the circumference of the seat, with the legs of the object 700 separating the distinct grasp regions. Additionally, twelve cylindrical grasp regions (including grasp region 714), each represent a set of potential grasps around the cross portions connecting adjacent sets of legs of object 700, with the grasp regions being separated by the vertical portions of the legs of the object. Additionally, eight cylindrical grasp regions (including grasp region 716), each represent a set of potential grasps around vertical sections of the legs of object 700 along the length of the leg, with the cross portions of the object 700 separating the grasp regions.

It should be appreciated that in some embodiments, not every portion of an object may be associated with a grasp region even though it may be possible to grasp the object at that location. For instance, the four bottom sections of the legs of object 700 shown in FIGS. 7A and 7B may not be associated with grasp regions due to only one end of those sections of the legs being bounded by a cross section, which may result in the grasp of those regions being less reliable than other regions on the object 700. In some embodiments, excluding certain regions of an object as potential grasp regions may reduce the search space associated with grasp region selection and/or may enable consideration of prior knowledge about an object that may otherwise be challenging to communicate to the grasp region selection process.

In some embodiments, a set of grasp regions for an object may be implemented as a sparse representation of the set of all possible grasps on an object, with the sparse representation being informed by prior knowledge about the object and/or a robot configured to grasp the object. For instance, each grasp region may describe bounds on where a given grasp strategy for a particular end effector of a robot may successfully grip an object. In this way, a grasp region may encode a set of potential grasps that can be achieved for a given grasp policy/algorithm of a robot. As an example, in the case of a robot having a gripper with multiple appendages, each grasp region may represent a set of potential grasps capable of being grasped by at least two opposing appendages of the gripper. If the grasp policy/algorithm of the robot is simple (e.g., just closing the two opposing appendages), small variations in the object geometry may affect whether a successful grasp may be achieved, which may result in smaller grasp regions. However, if the grasp policy/algorithm of the robot is more complex (e.g., a gripper with multiple appendages having multiple ways to wrap the appendages around an object to successfully grasp the object), such small variations in the object geometry may be less important when determining whether a secure grasp can be achieved, which may enable the use of larger grasp regions. In some embodiments, the sparse representation for a grasp region may be implemented as a parameterized grasping space (e.g., translations and rotations about a single axis of the grasping region) associated with a portion of the object. The parameterized grasping space may enable quick (e.g., near instantaneous) computation of different grasps within the space that enable the robotic device to grasp and/or re-grasp the portion of the object withing the parameterized grasping space as the object is manipulated by the robotic device. Without such a computationally efficient implementation for recalculating the grasp, the robotic device may more easily lose its grasp on the object by not being able to make quick adjustments of its grasping position when needed to maintain control of the object during manipulation.

As discussed in more detail below, some embodiments may be configured to associate one grasp region of the set of grasp regions with an end effector of a robotic device (e.g., a first claw end effector), and a grasp (e.g., an ideal grasp) from within the set of potential grasps of the associated grasp region may be determined for the end effector (e.g., using optimization). In some embodiments, multiple grasp regions may be associated with an end effector of a robotic device, and a grasp (e.g., an ideal grasp) may be determined for each of the associated grasp regions (e.g., by performing multiple optimizations in parallel). In some embodiments, a robotic device may include multiple end effectors (e.g., multiple claw end effectors), and each of the end effectors may be associated with one or more grasp regions for an object to determine how to grasp the object with one or more of the end effectors (e.g., to perform a bimanual grasp).

In some embodiments, information about the grasp quality and/or location of a grasp for one end effector of the robotic device may be used to inform (e.g., constrain) the location of a grasp (or selection of a grasp region) for another end effector of the robotic device. For instance, in the example object shown in FIG. 7B, a first end effector of the robotic device may be associated with grasp region 714 and a second end effector of the robotic device may be associated with grasp region 716, such that a bimanual grasp of the object is performed using grasps on either side of the object. In some embodiments, using information about the grasp quality and/or location of a grasp for one end effector to inform the location of a grasp region for association with another end effector may be used to improve the stability of the object when grasped with both end effectors. In other embodiments, using such information may be helpful in ensuring that the object can be manipulated (e.g., moved, placed) as desired after the object is grasped. In some embodiments, a bimanual grasp may be selected when the grasps by the two end effectors does not result in collision between the end effectors.

Returning to the computing architecture 304 shown in FIG. 3, grasp region determination module 320 may be configured to determine parameters (e.g., the shape and extents) of grasp regions for an object in any suitable way. In some embodiments, the parameters of the grasp region(s) for an object may be determined, at least in part, using simulation (e.g., Monte Carlo simulation). Using simulation to generate grasp regions may help ensure that the grasp regions are robust to errors in the estimated pose of the object, robust to the shape of the object, and/or robust to potential external forces, in a quantitative manner. As described above, in some embodiments, the determination of a set of grasp regions for an object may be performed offline, and selection of a grasp region to use with a particular end effector, and determination of a grasp from the set of grasps within the selected grasp region may be performed online during operation of the robot.

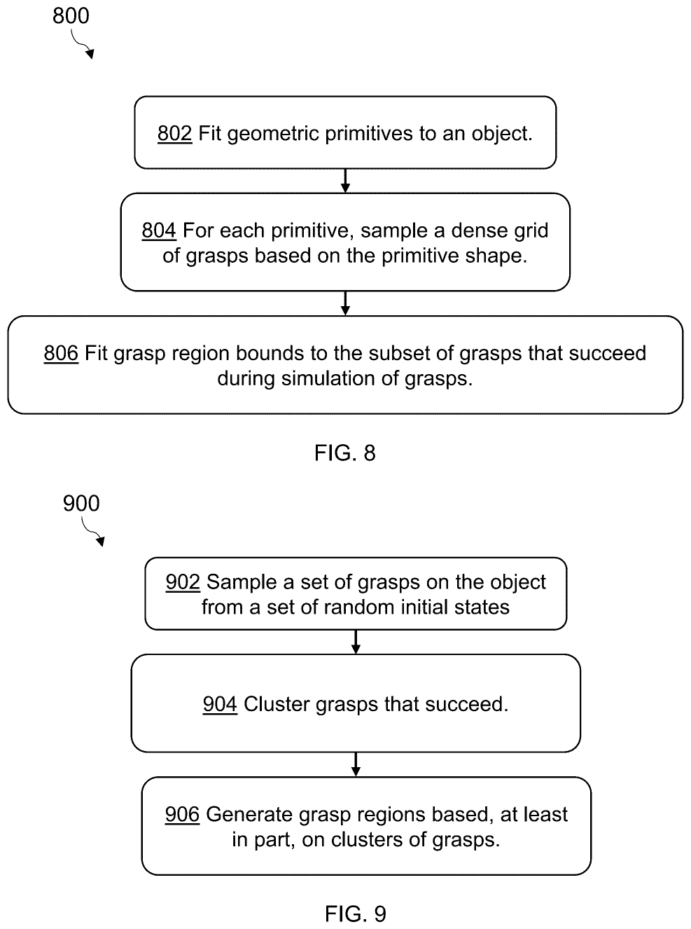

FIG. 8 illustrates a process 800 for using simulation to determine one or more grasp regions for an object, in accordance with some embodiments. Process 800 begins in act 802, where one or more geometric primitives are fit to an object. Non-limiting examples of geometric primitives include disks, rings, cylinders, and prisms. For example, a cylinder as a geometric primitive may be fit to the handle of the object shown in FIG. 6A, a disk as a geometric primitive may be fit to the seat of the stool shown in FIG. 7A, etc. In some embodiments, one or more images of the object (e.g., determined by perception module 308 shown in FIG. 3) may be annotated with the one or more geometric primitives. The annotation may be performed automatically and/or an image of the object may be provided on a user interface and the object may be annotated based, at least in part, on user input provided via the user interface. Process 800 then proceeds to act 804, where a dense grid of grasps is sampled for each of the geometric primitives fit to the object in act 802. The dense grid of grasps may be different for each type of primitive shape. For instance, a dense grid of grasps having rotations around and translations along an axis of a cylinder may be sampled for a cylindrical primitive shape, whereas a dense grid of grasps around the circumference of a disk may be sampled for disk primitive shape. It should be appreciated that other types of grid sampling may additionally or alternatively be used. Process 800 then proceeds to act 806 where grasps at each of the grasp positions in the dense grid of grasps are simulated and bounds on the grasp regions are fit to the largest subset of adjacent simulated grasps that succeed during the simulation.

FIG. 9 illustrates an alternate process 900 for using simulation to determine one or more grasp regions for an object, in accordance with some embodiments. Process 900 begins in act 902, where a set of grasps on an object are simulated from a set of initial states (e.g., random initial states). Process 900 then proceeds to act 904, where grasps that succeed during simulation are clustered. Any suitable clustering techniques may be used to generate the clusters of grasps. Process 900 then proceeds to act 906, where one or more grasp regions are generated based, at least in part, on the clusters of grasps.

Returning to the computing architecture 304 shown in FIG. 3, the output of the grasp region determining module 320 may be provided to robot control module 328. Robot control module 328 can receive one or more high-level target robot behaviors and compute specific movements (e.g., whole-body trajectories or other suitable movement parameters) for the robot to perform, while taking into account real-time variations in environmental conditions. The grasp region information output from the grasp region determination module 320 may be used to inform (e.g., constrain) an optimization performed by the robot control module 328. For example, the robot control module 328 may be configured to optimize (e.g., jointly) a grasp on the object by an end effector of the robotic device 300 using the grasp region information and the robot posture and stance, which may allow for more varied, robust, and/or reachable interactions between the robotic device 300 and objects in its environment. In some embodiments, optimizing the grasp on the object is performed by selecting a grasp within a grasp region that has been associated with an end effector of the robotic device. For instance, for a robotic device that includes two end effectors (e.g., the humanoid robotic device shown in FIG. 2B), a first end effector may be associated with a first grasp region and a second end effector may be associated with a second grasp region. Optimizing the grasp on the object may be performed by selecting a grasp for each of the end effectors within its associated grasp region. In some embodiments, a particular grasp region may not be associated with an end effector prior to optimization. Rather, an end effector may be associated with each grasp region of a set of grasp regions, and optimization may be performed within each of the associated grasp regions to determine a desired grasp on the object.

In some embodiments, selecting a grasp within a grasp region may depend, at least in part, on an estimated grasp quality metric associated with different potential grasps within the grasp region. For instance, when using optimization to select the grasp, the optimization may be configured to encourage selection of “more stable” grasps within a grasp region compared to “less stable” grasps based on a grasp quality associated with the set of potential grasps within the grasp region. In some embodiments, the grasp quality metric may be based, at least in part, on one or more model-based or data-driven grasp scoring metrics. Such metrics may be based on a grasping policy/algorithm of the robot and/or the object shape.

In some embodiments, even though a robotic device may have two (or more) end effectors, it may be determined that grasping an object with a single end effector is preferred. For instance, if the handle of an object to be grasped is too small to use bimanual grasping, one end effector may be controlled to grasp the handle, and the other end effector may be controlled to not interact with the object, to support the object on the bottom or side of the object while lifting, or by performing some other action.

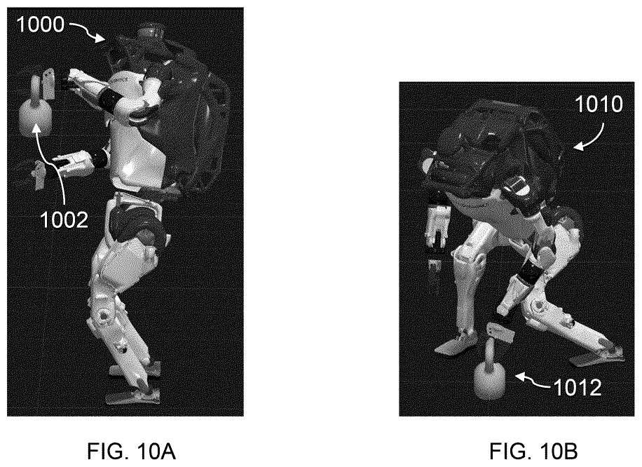

In some embodiments, the robot control module 328 may determine how to grasp an object based, at least in part, on a manipulation goal of the robotic device. For instance, the manipulation goal may include how the object is to be placed. For instance, if the object is to be moved from one location on a surface to another location on the same surface, it may be desired to grasp the object using a more vertical grasp if possible (e.g., see FIG. 10B). However, if the object is to be moved from a low position to a high position (e.g., on a shelf), a grasp position on the object may be more horizontal (e.g., see FIG. 10A) to enable placement on the shelf.

In some embodiments, it may be desirable to maintain the same grasp on an object throughout a pick-and-place operation. In such instances, determining a grasp by the robot control module 328 may include enforcing a constraint in the optimization that the selected grasp be compatible with both a pick operation and a place operation of the robotic device. In other embodiments, it may be permissible to change the grasp of the object during a pick-and-place operation (or any other operation in which an object is grasped and manipulated). In such embodiments, the use of grasp regions as described herein may facilitate such re-grasping by enabling a smooth transition (e.g., a sliding re-grasp along a single axis of the grasp region) from one grasp to another grasp within the same grasp region. Re-grasps of an object within the same grasp region may involve a simpler motion of the robotic device and/or less time to execute compared to a complete re-grasp of the object (e.g., a re-grasp that requires the robotic device to set the object down and re-grasp it). For example, performing a complete re-grasp of the object may require the optimization performed in the robot control module 328 to be re-executed, which may not necessarily be the case if the re-grasp is performed within the same grasp region. In some embodiments, multiple re-grasps within the same grasp region may be preferred compared to a single complete re-grasp in which the object must be released from the robotic device's grasp. In this way, grasp regions as described herein may be a useful construct for both grasp planning and also updating the grasp of an object as the object is manipulated (e.g., when the object slips in the end effector of the robotic device, to achieve some manipulation objective, etc.).

In some embodiments, the joint optimization of the grasp on an object and the whole-body trajectory of the robot may be subject to various constraints including, but not limited to, a balance constraint of the robot when manipulating the object, a collision constraint (e.g., a self-collision constraint and/or an external collision constraint) associated with the robot when manipulating the object, a gaze constraint associated with a camera of the robotic device when manipulating the object, and a kinematic constraint of the robot associated with the object grasp being within reach of the robot's gripper. For instance, the gaze constraint may require the grasped object to be within a field of view of at least one camera of the robot at all times during manipulation of the object.

The inverse dynamics module 332 can receive output from the robot control module 328 and output a reference joint position and/or torque for each of the robotic joint servo controllers 336, which can be provided to actuators of the robotic device 300 to enable the robotic device 300 to execute its planned movement. In some embodiments, the inverse dynamics module 332 can track a desired wrench of the robotic device 300 as closely as possible or desired in a given situation. In some embodiments, the inverse dynamics module 332 can map a desired robot pose and/or one or more external wrenches to joint torques.

In some embodiments, inverse dynamics module 332 may receive grasp region information as input from grasp region determination module 320, and the grasp region information may be used by the inverse dynamics module 332 to optimize (e.g., jointly) selection of a grasp on the object by an end effector of the robotic device 300 and the reference joint position and/or torque for each of the robotic joint servo controllers 336. In some embodiments, inverse dynamics module 332 may include a more detailed kinematics description of the robot compared to robot control module 328. Considering the grasp region information at multiple and/or different stages of the robot control processing pipeline may enable a wider variety of grasps that can be selected to manipulate objects. For example FIGS. 10A and 10B show how an object can be grasped differently based on the height of the object relative to the current pose of the robotic device. In the example of FIG. 10A, the object 1002 is located at a height off of the ground and a horizontal grasp on the handle of the object 1002 may be selected to enable the robotic device 1000 to grasp the object 1002 (e.g., grasping the top of the handle may be awkward and/or not possible due to the height of the object). In the example of FIG. 10B, the object 1012 is located on the ground, and a vertical grasp on the top of the handle of the object 1012 may be selected to enable the robotic device 1010 to more easily grasp the handle than if a horizontal grasp of the handle (e.g., as shown in FIG. 10A) was attempted. In this way, using grasp regions to specify a desired grasp enables an optimization technique to select grasp poses that enable minimizing other objectives (e.g., deviation from a nominal standing posture) for the robotic device.

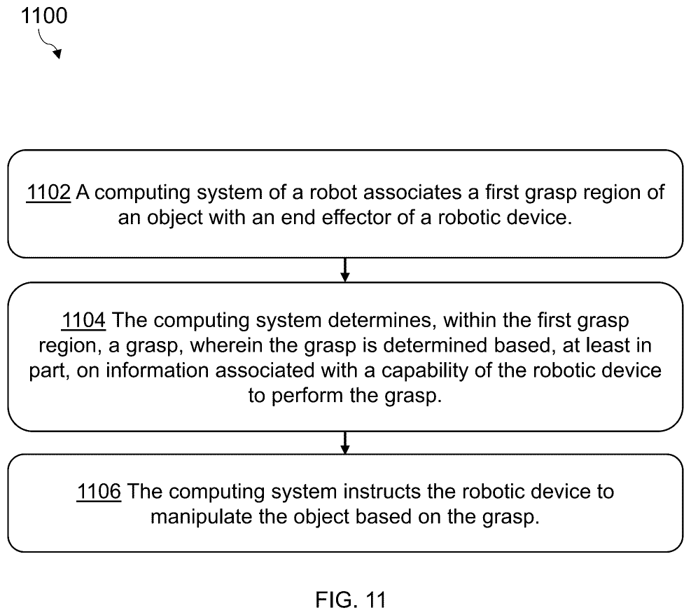

FIG. 11 is a flowchart of an exemplary computer-implemented method 1100, according to an illustrative embodiment of the invention. In a first act 1102, a computing system of a robot associates a first grasp region of an object with an end effector of a robotic device. In a second act 1104, the computing system determines, within the first grasp region, a grasp, wherein the grasp is determined based, at least in part, on information associated with a capability of the robotic device to perform the grasp. In a third act 1106, the computing system instructs the robot to manipulate the object based, at least in part, on the determined grasp.

A number of implementations have been described. Nevertheless, it will be understood that various modifications may be made without departing from the spirit and scope of the disclosure.

1. A computer-implemented method, comprising:
associating a first grasp region of an object with an end effector of a robotic device, wherein the first grasp region includes a set of potential grasps achievable by the end effector of the robotic device;
determining, within the first grasp region, a grasp from among the set of potential grasps, wherein the grasp is determined based, at least in part, on information associated with a capability of the robotic device to perform the grasp; and
instructing the robotic device to manipulate the object based on the grasp.

2. The method of claim 1, wherein the end effector of the robotic device includes a gripper having a set of appendages, and
the first grasp region has a shape capable of being grasped by at least two appendages of the set of appendages.

3. The method of claim 2, the shape capable of being grasped by at least two appendages of the set of appendages includes a cylinder, a prism or a disk.

4. The method of claim 2, wherein
the shape capable of being grasped by at least two appendages of the set of appendages is defined along a single axis, and
the set of potential grasps within the first grasp region include grasps having different rotations around the single axis and/or translations along the single axis.

5. The method of claim 1, wherein determining, within the first grasp region, a grasp, comprises determining the grasp based, at least in part, on a pose of the robotic device and/or a manipulation goal of the robotic device.

6. The method of claim 5, wherein the grasp is determined based, at least in part, on a placement location of the object associated with the manipulation goal and/or a location of the object prior to manipulating the object.

7. The method of claim 1, wherein determining, within the first grasp region, a grasp, comprises determining the grasp based, at least in part, on one or more of a balance constraint of the robotic device when manipulating the object, a collision constraint associated with the robotic device when manipulating the object, a gaze constraint associated with a camera of the robotic device when manipulating the object, or one or more kinematics constraints of the robotic device.

8. The method of claim 7, wherein the collision constraint is a self-collision constraint of the robotic device and/or an external collision constraint of the robotic device with an object in an environment of the robotic device.

9. The method of claim 1, wherein determining, within the first grasp region, a grasp, comprises performing an optimization that considers for each potential grasp in the set of potential grasps within the first grasp region:
a location of the potential grasp within the first grasp region, and
one or more kinematic or reachability constraints of the robotic device to achieve the potential grasp.

10. The method of claim 9, wherein
the first grasp region has a first axis, and
the set of potential grasps within the first grasp region include potential grasps at different rotations around the first axis and/or translations along the first axis.

11. The method of claim 1, wherein manipulating the object based on the grasp comprises controlling the robotic device to grasp the object using the grasp.

12. The method of claim 1, wherein manipulating the object based on the grasp comprises controlling the robotic device to re-grasp the object using the grasp.

13. The method of claim 12, wherein re-grasping the object is performed during movement of the object from a first location to a second location.

14. The method of claim 12, wherein re-grasping the object comprises rotating a grasp of the object by the end effector of the robotic device around a first axis of the first grasp region and/or translating the grasp of the object by the end effector of the robotic device along the first axis of the first grasp region.

15. The method of claim 1, wherein manipulating the object based on the grasp comprises controlling the robotic device to place the object at a location using the grasp.

16. The method of claim 1, wherein the end effector is a first end effector of the robotic device, the grasp is a first grasp for the first end effector, the information associated with the capability of the robotic device to perform the grasp is first information, and the robotic device includes a second end effector, the method further comprising:
assigning a second grasp region to the second end effector;
determining, within the second grasp region, a second grasp for the second end effector, wherein the second grasp is determined based, at least in part, on second information associated with a capability of the robotic device to perform the second grasp; and
manipulating the object based on the first grasp and the second grasp.

17. The method of claim 16, wherein determining the first grasp and the second grasp comprises using a technique that considers the first information and the second information.

18. The method of claim 16, wherein the first grasp region is located on an opposite side of the object from the second grasp region and/or the first grasp region is located at a different height on the object from the second grasp region to improve stability of the object when manipulated by the robotic device.

19. A computing system of a robot, the computing system comprising:
data processing hardware; and
memory hardware in communication with the data processing hardware, the memory hardware storing instructions that when executed on the data processing hardware cause the data processing hardware to perform operations comprising:
associating a first grasp region of an object with an end effector of the robot, wherein the first grasp region includes a set of potential grasps achievable by the end effector of the robot;
determining, within the first grasp region, a grasp, wherein the grasp is determined based, at least in part, on information associated with a capability of the robot to perform the grasp; and
instructing the robot to manipulate the object based on the grasp.

20. A robot comprising:
an end effector;
data processing hardware; and
memory hardware in communication with the data processing hardware, the memory hardware storing instructions that when executed on the data processing hardware cause the data processing hardware to perform operations comprising:
associating a first grasp region of an object with the end effector, wherein the first grasp region includes a set of potential grasps achievable by the end effector;
determining, within the first grasp region, a grasp, wherein the grasp is determined based, at least in part, on information associated with a capability of the robot to perform the grasp; and
instructing the robot to manipulate the object based on the grasp.
